(19) United States
(12) Patent Application Publication
(10) Pub. No.: US 2018/0373212 A1
(43) Pub. Date: Dec. 27, 2018

(54) INTERFACE-CONTROL DEVICE AND RELATED METHOD

(71) Applicant: Sengled Co., Ltd., Shanghai (CN)

(72) Inventors: Xinwang LIN, Shanghai (CN); Jinxiang SHEN, Shanghai (CN)

(73) Assignee: Sengled Co., Ltd., Shanghai (CN)

(21) Appl. No.: 15/747,069

(22) PCT Filed: Dec. 13, 2016
(86) PCT No.: PCT/CN2016/109561

§ 371 Date: Jan. 23, 2018

(30) Foreign Application Priority Data
Dec. 29, 2015 (CN) 201511008827.8

(51) Int. Cl. G05B 19/042

(52) U.S. Cl. CPC G05B 19/0423; G05B 2219/21059; G05B 2219/21114; G05B 2219/21087

(57) ABSTRACT

The present disclosure provides device and method for interface-control. The interface-control device includes: a control module having a controller and a first interface coupled to the controller, and a sensor module having a sensor circuit and a second interface coupled to the sensor circuit, the first interface and the second interface being connected through a matching connection. The first interface and the second interface each includes a first function pin for transferring first data reflecting a sensor type of the sensor circuit from the sensor circuit to the controller. The controller determines the sensor type of the sensor circuit based on the first data and processes measured data from the sensor circuit based on the sensor type.

### CROSS-REFERENCES TO RELATED APPLICATIONS

This application claims the priority of Chinese Patent Application No. 201511008827.8 filed on Dec. 29, 2015, the entire content of which is incorporated herein by reference.

### FIELD OF THE DISCLOSURE

The present disclosure relates to the field of light emitting diode (LED) technologies and, more particularly, relates to an interface-control device and a related interface-control method.

### BACKGROUND

Sensor modules may be used to conveniently obtain a great amount of measurable data by measuring environment parameters such as temperatures and humidity.

In conventional technology, a sensor module is often used with a control module. The sensor module is often used to measure data, and the control module is used to process the measured data or measurable data obtained from the sensor module. Because the control module needs to obtain measured data from the sensor module, a matching interface circuit is often required between the control module and the sensor module.

However, in conventional technology, different interface circuits may be used to connect different sensor modules with control modules. As a result, for a sensor module, when a different control module is used, the interface circuit connecting the sensor module and the control module needs to be redesigned to match the new control module.

The disclosed devices and methods are directed to solve one or more problems set forth above and other problems.

### BRIEF SUMMARY OF THE DISCLOSURE

An aspect of the present disclosure provides an interface-control device, including: a control module having a controller and a first interface coupled to the controller, and a sensor module having a sensor circuit and a second interface coupled to the sensor circuit, the first interface and the second interface being connected through a matching connection. The first interface and the second interface each includes a first function pin for transferring first data reflecting a sensor type of the sensor circuit from the sensor circuit to the controller. The controller determines the sensor type of the sensor circuit based on the first data and processes measured data from the sensor circuit based on the sensor type.

Optionally, the first data include voltage data corresponding to the sensor type of the sensor circuit.

Optionally, the first interface and the second interface each further includes a second function pin for transferring the measured data received from the sensor circuit to the controller.

Optionally, the sensor circuit includes: a voltage-dividing sub-circuit for outputting the first data, an output terminal of the voltage-dividing sub-circuit being coupled to the first function pin of the second interface; and a sensor sub-circuit for outputting the measured data, an output terminal of the sensor sub-circuit being coupled to the second function pin of the second interface.

Optionally, the first data is address data corresponding to the sensor type of the sensor circuit.

Optionally, the first function pins transfer the address data and the measured data from the sensor circuit to the controller.

Optionally, the first interface and the second interface may each be any one of a universal serial bus (USB) interface, a micro-USB interface, a 3.5 mm headphone jack, a male pin header connector, or a female pin header connector.

Optionally, the interface-control device further includes a communication module coupled to the controller for transferring data between the controller and a server.

Optionally, the communication module is one or more of a wireless fidelity (WiFi) communication module, a global system for mobile communications (GSM) communication module, a code division multiple access (CDMA) communication module, and a long term evolution (LTE) communication module.

Optionally, the interface-control device further includes a light emitting module coupled to the controller for providing lighting.

Optionally, the light emitting module includes one or more light emitting diodes (LEDs).

Another aspect of the present disclosure provides an interface-control method for controlling the disclosed interface-control method, including: obtaining the first data based on a signal transferred by the first function pin of the first interface, the first interface being coupled to the control module, first data indicating the sensor type of the sensor circuit; determining a processing type corresponding to the sensor circuit based on the sensor type of the sensor circuit; and processing the measured data obtained from the sensor circuit based on the processing type corresponding to the sensor circuit.

Optionally, the first data include one or more of voltage data and address data.

Optionally, obtaining the first data through the first function pin includes: determining if the signal is a DC signal; if the signal is a DC signal, obtaining the voltage data based on the DC signal; and if the signal is not a DC signal, obtaining the address data based on a square wave signal transferred by the first function pin.

The interface-control method according to claim 12, further comprising: after processing the measured data, sending a result formed by processing the measured data to a server such that a user receives the result through a mobile device connected to the server.

Optionally, the interface-control method further includes: after processing the measured data, receiving a command from a user to control on and off states of a light emitting module connected to the controller.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary interface-control device consistent with various disclosed embodiments of the present disclosure;

FIG. 2 illustrates another exemplary interface-control device consistent with various disclosed embodiments of the present disclosure;

FIG. 3 illustrates an exemplary sensor circuit consistent with various disclosed embodiments of the present disclosure;

FIG. 4A illustrates exemplary function pins of a first interface and a second interface consistent with various disclosed embodiments of the present disclosure;

FIG. 4B illustrates other exemplary function pins of a first interface and a second interface consistent with various disclosed embodiments of the present disclosure;

FIG. 5 illustrates another exemplary interface-control device consistent with various disclosed embodiments of the present disclosure;

FIG. 6 illustrates a flow chart of an exemplary process for interface control consistent with various disclosed embodiments of the present disclosure;

FIG. 7 illustrates a flow chart of an exemplary process for interface control consistent with various disclosed embodiments of the present disclosure; and

FIG. 8 illustrates a block diagram of controller used in various disclosed embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

One aspect of the present disclosure provides an interface-control device.

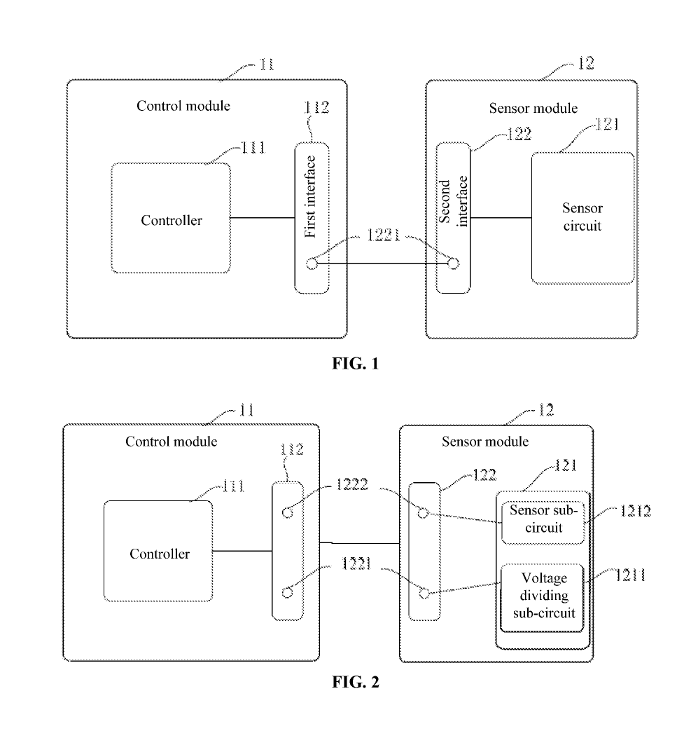

FIG. 1 illustrates the structure of an exemplary interface-control device provided by the present disclosure. As shown in FIG. 1, the disclosed interface-control device may include a control module 11 and a sensor module 12.

The control module 11 may include a controller 111 and a first interface 112 connected to or coupled to the controller 111. The sensor module 12 may include a sensor circuit 121 and a second interface 122 connected to the sensor circuit 121. The first interface 112 and the second interface 122 may be connected through a matching connection. In the present disclosure, terms “connected to” and “coupled to” may be interchangeable. An objected may be coupled to another object through any suitable couplings, e.g., mechanical coupling, electrical coupling, and wireless coupling.

The first interface 112 and the second interface 122 may each include a first function pin 1221.

The sensor circuit 121 may transfer/output first data/information through first function pin 1221 to the controller 111. The first data may indicate the sensor type of the sensor circuit 121.

The controller 111 may determine the sensor type of the sensor circuit 121 based on the first data. The controller 111 may process the measured data obtained by the sensor circuit 121 based on the sensor type of the sensor circuit 121.

The sensor circuit 121 may be, for example, one or more of a temperature sensor, a humidity sensor, an infrared sensor, an ambient light sensor, a sound sensor, a pressure sensor, a combustible gas sensor, an air quality sensor, a smoke sensor, an air purification sensor, a vibration detecting sensor, an audio module, a voice sampling module, and an image sampling module.

The controller 111 may be, for example, one or more of a central processing unit (CPU), micro-controller unit (MCU), and a digital signal processing (DSP).

In various embodiments of the present disclosure, the matching connection between the first interface and the second interface may be referred to as, for example, if the first interface is a universal serial bus (USB) male connector, the second interface may be a USB female connector; if the first interface is a female pin header, the second interface may be a male pin header; and vice versa. The specific structures of the first interface and the second interface should not be limited by the embodiments of the present disclosure.

In one embodiment, the first interface 112 in the control module 11 and the second interface 122 in the sensor module 12 may each include a first function pin 1221. The controller may determine the sensor type of the sensor circuit 121 based on the first data transferred through the first function pin 1221. Accordingly, a sensor module 12 containing a different type of sensor circuit 121 may be connected to the control module 11 through the same interface. Thus, the interface circuit needs not be redesigned when a different sensor module is connected to the control module 11.

FIG. 2 illustrates the structure of another interface-control device provided by the present disclosure. Based on the structure shown in FIG. 1, the sensor circuit 121 in the interface-control device illustrated in FIG. 2 may further include a voltage-dividing sub-circuit 1211 and a sensor sub-circuit 1212. The voltage-dividing sub-circuit 1211 may output the first data. The sensor sub-circuit 1212 may output measured data obtained by the sensor module 12.

Accordingly, the first interface 112 and the second interface 122 may each further include a second function pin 1222. The sensor sub-circuit 1222 may output the measured data through the second function pin 1222.

The output terminal of the voltage-dividing sub-circuit 1211 may be connected to the first function pin 1221 of the second interface 122. The output terminal of the sensor sub-circuit 1212 may be connected to the second function pin 1222 of the second interface 122.

In one embodiment, the first data may be voltage data.

In various embodiments, different sensor types may correspond to different voltage data. Example of the correspondence relation may be shown in Table 1.

TABLE 1

| Voltage Data | Sensor Type |
|---|---|
| 0 V | No sensor |
| 0.2 V | Humidity sensor |
| 0.4 V | Infrared sensor |
| 0.6 V | Ambient light sensor |
| 0.8 V | Sound sensor |
| 1.0 V | Pressor sensor |
| 1.2 V | Combustible gas sensor |
| 1.4 V | Air quality sensor |
| 1.6 V | Temperature sensor |
| 1.8 V | Smoke sensor |
| 2.0 V | Air purification sensor |
| 2.2 V | Vibration detecting sensor |
| 2.4 V | Speaker module |
| 2.6 V | Voice sampling module |
| >2.6 V | Hold |

For example, when the voltage data is equal to 0.2 V, the sensor type may be a humidity sensor.

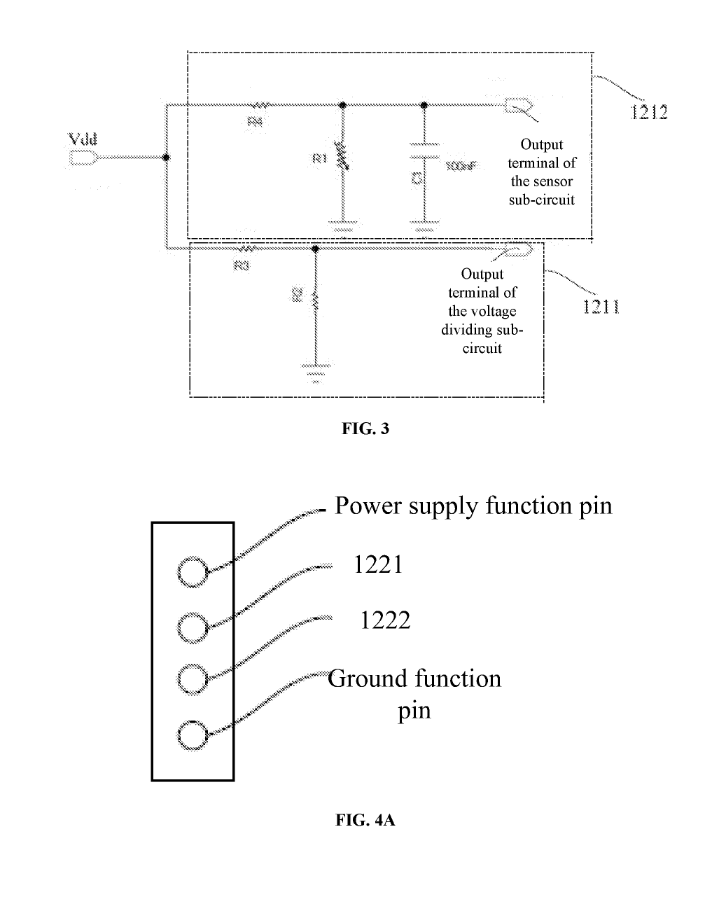

When the sensor circuit 121 is a temperature sensor, the sensor circuit 121 may be exemplified in FIG. 3. As shown in FIG. 3, R1 may be negative temperature coefficient (NTC) resistor, and may be used as a temperature sensor. R2, R3, and R5 may be voltage-dividing resistors. R2 and R3 may form the voltage-dividing sub-circuit 1211. Vdd may be the voltage of the power supply, providing electric power for the sensor sub-circuit 1212 and the voltage-dividing circuit 1211. C1 may be a filter capacitor. In one embodiment, the capacitance of C1 may be 100 nF. The output terminal of the voltage-dividing sub-circuit 1211 may be connected with the first function pin 1221 of the second interface. The output terminal of the temperature sensor may be connected with the second function pin 1222 of the second interface 122.

Assuming Vdd is equal to 3.2 V, and R2 and R3 may have same resistance. The output terminal of the voltage-dividing sub-circuit 1211 may output a voltage of 1.6 V, i.e., the first data may be 1.6 V. Accordingly, the controller may determine the sensor type to be a temperature sensor based on the first data outputted by the first function pin.

The first interface and the second interface may each be any one of a USB interface, a micro-USB interface, a 3.5 mm headphone jack, a male pin header connector, or a female pin header connector.

The function pins may be described in detail. In an example, the first interface and the second interface may be a 3.5 mm headphone jack.

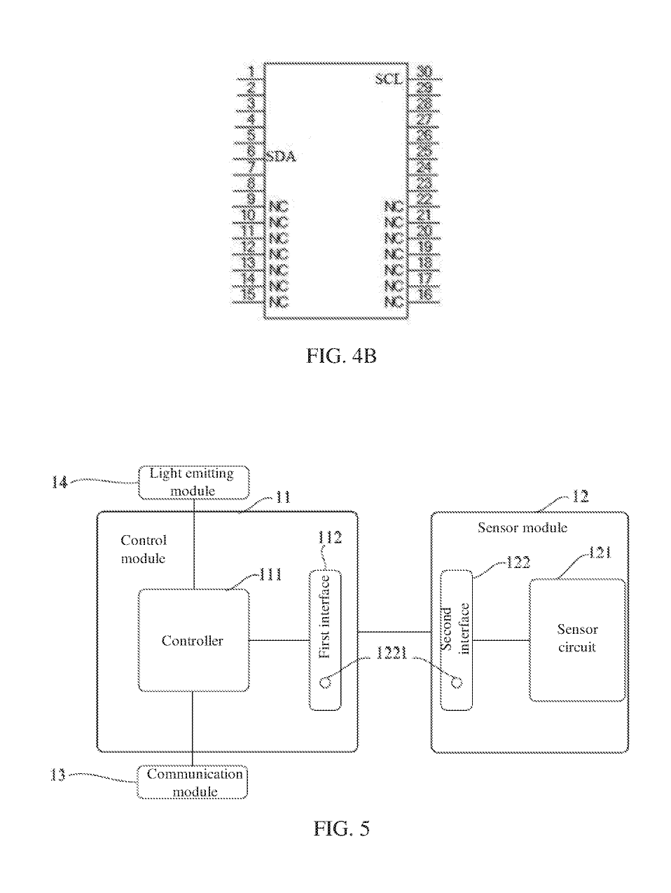

As shown in FIG. 4A, the first interface and the second interface may each include a power supply function pin, a ground function pin, a first function pin 1221, and a second function pin 1222. The power supply function pin may be connected with the power supply or applied with the power supply voltage Vdd. The ground function pin may be grounded.

For illustrative purposes, FIG. 4A include one second function pin as an example. In various embodiments, the first interface and the second interface may also include more than one second function pin. Specifically, the number of second function pins may be associated with the number of function pins, e.g., one or more, required for outputting the measured data of the sensor circuit. For example, for a voltage sensor, only one function pin is required to output the measured data of the voltage sensor, so that the number of the second function pin may be one. For an image sampling module, more than one function pin is required to output the measured data of the image sampling module, so that the number of the second function pins may be more than one.

For illustrative purposes, the sensor circuits described in the embodiments of the present disclosure may be sensor circuits that output analog signals/voltages. In other various embodiments, the voltage-dividing sub-circuit may also be sensor circuits that output digital signals/voltages.

In one embodiment, the first interface in the control module and the second interface in the sensor module may each include a first function pin. The controller may determine the sensor type of the sensor circuit based on the voltage data outputted by the first function pin. Accordingly, a sensor module containing a different type of sensor circuit may be connected to the control module through the same interface. Thus, the interface circuit may not need to be redesigned when a different sensor module is connected to the control module. Meanwhile, the present disclosure may also reduce the re-development of the control module. Less time is needed for the development of the interface-control device, and the manufacture of the interface-control device is cheaper.

Further, based on the disclosed interface-control devices illustrated in FIGS. 1-4A, when the sensor circuit outputs digital signals/voltages, the first data may be address data.

In some embodiments, the address data may be an address data of an inter-integrated circuit (I²C).

In various embodiments, different sensor types may correspond to different address data. Example of the correspondence relation may be shown in Table 2.

TABLE 2

| Voltage Data | Sensor Type |
|---|---|
| 0000 | No sensor |
| 0001 | Humidity sensor |
| 0010 | Infrared sensor |
| 0011 | Ambient light sensor |
| 0100 | Sound sensor |
| 0101 | Pressor sensor |
| 0110 | Combustible gas sensor |
| 0111 | Air quality sensor |
| 1000 | Temperature sensor |
| 1001 | Smoke sensor |
| 1010 | Air purification sensor |
| 1011 | Vibration detecting sensor |
| 1100 | Speaker module |
| 1101 | Voice sampling module |
| 1110 | Image sampling module |
| . . . | Hold |

In some embodiments, the first function pin may output address data and also be used as one of the function pins for outputting measured data of the sensor circuit.

For example, the first interface and the second interface may each be a different one of a male pin header and a female pin header corresponding to a camera module. The first function pin may be described as follows.

As shown in FIG. 4B, function pins 1-8 and function pins 23-30 may be function pins associated with the camera module. Function pin 6 SDA may be the data line of the I²C bus line. Function pin 30 SCL may be the clock line of the I²C bus line. Function pin 30 may be used as the first function pin to, so that the sensor circuit may output address data through function pin 30.

In some embodiments, for the interface shown in FIG. 4B, a function pin not associated with the camera module, e.g., function pin 20, may also be used as the first function pin for the sensor circuit to output voltage data.

In one embodiment, the first interface in the control module and the second interface in the sensor module may each include a first function pin. The controller may determine the sensor type of the sensor circuit based on the address data outputted by the first function pin. A sensor module containing a different type of sensor circuit may be connected to the control module through the same interface. Thus, the interface circuit may not need to be redesigned when a different sensor module is connected to the control module. Meanwhile, the present disclosure may also reduce the re-development of the control module. Less time is needed for the development of the interface-control device, and the manufacture of the interface-control device is cheaper.

FIG. 5 illustrates the structure of another exemplary interface-control device provided by the present disclosure. Based on the structure shown in FIG. 1, the interface-control device shown in FIG. 5 may further include a communication module 13. The communication module 13 may be connected with the controller 111 to facilitate communication between the controller 111 and servers.

For example, controller 111 may receive and process the measured data obtained from the sensor circuit 121, and further send the result of the data processing to the servers through the communication module 13.

Correspondingly, a user may communication with the server and obtain the result of the data processing from the server through a mobile terminal, e.g., a mobile phone and a tablet computer.

The measured data obtained by the sensor circuit may correspond to the sensor type of the sensor circuit. For example, the measured data obtained by a pressure sensor may be pressure data; the measured data obtained by a humidity sensor may be humidity data; the measured data obtained by a temperature sensor may be temperature data; the measured data obtained by an air quality sensor may be air quality data, and so on.

In some embodiments, the communication module 13 may be one or more of a wireless fidelity (WiFi) communication module, a global system for mobile communications (GSM) communication module, a code division multiple access (CDMA) communication module, a long term evolution (LTE) communication module, and other suitable communication modules.

In some embodiments, the disclosed interface-control device may further include a light emitting module 14. The light emitting module 14 may be connected with the controller 111 to provide lighting.

In some embodiments, the light emitting module 14 may be one or more light emitting diodes (LEDs).

In one embodiment, the controller may communication with servers through the communication module so that the controller may send the result of the data processing to the server. The controller may process the measured data obtained by the sensor circuit and obtain the result of the data processing.

In some embodiments, the light emitting module 14 may be a lighting lamp providing general lighting in an indoor or outdoor space. Controller 111 may receive and process the measured data obtained from the sensor circuit 121, and further send the result of the data processing to the servers through the communication module 13. The controller 111 may control the light emitting module 14 based on the measured data obtained from the sensor circuit 121. For example, the sensor circuit 121 may be an infrared sensor. Based on the readings of the sensor (e.g., human movement detected), the controller 111 may turn the lighting emitting module 14 on or off, or adjust the brightness level of the light provided by the lighting emitting module 14.

In some embodiments, the light emitting module 14 may be an indicator light instead of a lighting unit to provide general lighting. The light emitting module 14 may display light of different color and brightness based on the data read form the sensor circuit 121. For example, the sensor circuit 121 may be an air quality sensor. The controller 111 may adjust the color of the light emitting module 14 based on the reading from the air quality sensor, e.g., turning the light red when the air quality is poor, turning the light green when the air quality is acceptable.

In some embodiments, the light emitting module 14 may be an indicator light together with a lighting unit to provide general lighting. The light emitting module 14 may display light of different color and brightness based on the data read form the sensor circuit 121. For example, the sensor circuit 121 may be a smoke sensor. The controller 111 may adjust the color of the light emitting module 14 based on the reading from the smoke sensor, e.g., turning the indicator light red and turning on the general when certain amount of smoke is detected; turning the indicator light green and turning off the general when no (or little) smoke is detected.

Another aspect of the present disclosure provides an interface-control method.

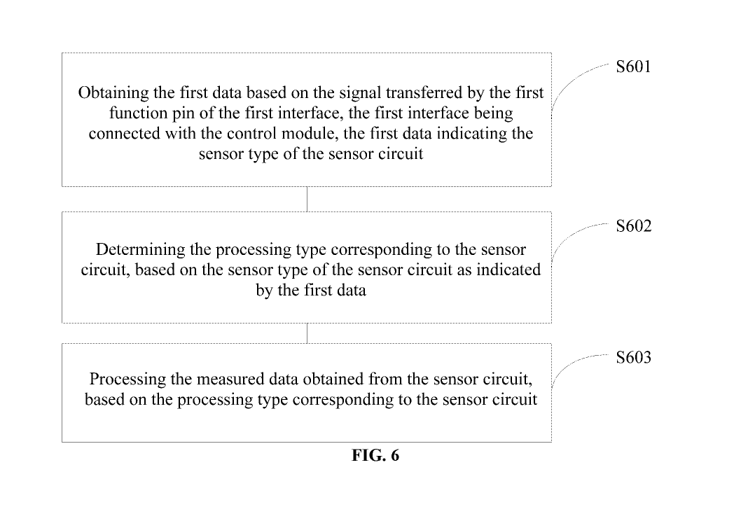

FIG. 6 illustrates a flow chart of an exemplary process of the interface-control method. The controller in the control module may execute the process. As shown in FIG. 6, the process may include steps S601-S603.

In step S601, based on the signal transferred by the first function pin of the first interface, the controller may obtain the first data. The first interface may be connected with the control module. The first data may indicate the sensor type of the sensor circuit connected to the control module through the first interface.

In some embodiments, the first data may be voltage data or address data.

In step S602, the controller may determine the processing type corresponding to the sensor circuit, based on the sensor type of the sensor circuit as indicated by the first data.

In step S603, the controller may process the measured data obtained from the sensor circuit, based on the processing type corresponding to the sensor circuit.

In one embodiment, the first data may be used to indicate the sensor type of the sensor circuit, and the processing type corresponding to the sensor circuit may be determined. Further, based on the processing type corresponding to the sensor circuit, the measured data obtained from the sensor circuit may be processed. Thus, the control module may process data for sensor circuits of different sensor types.

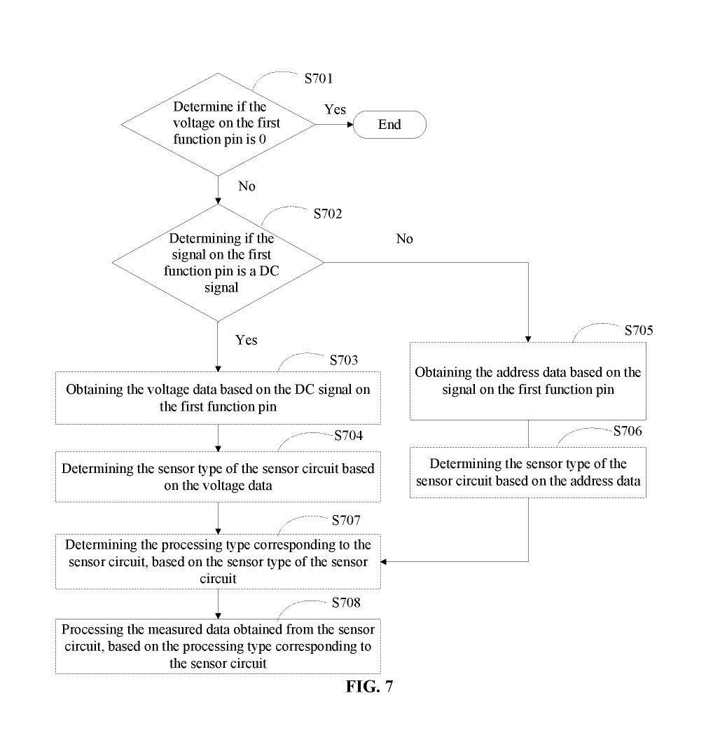

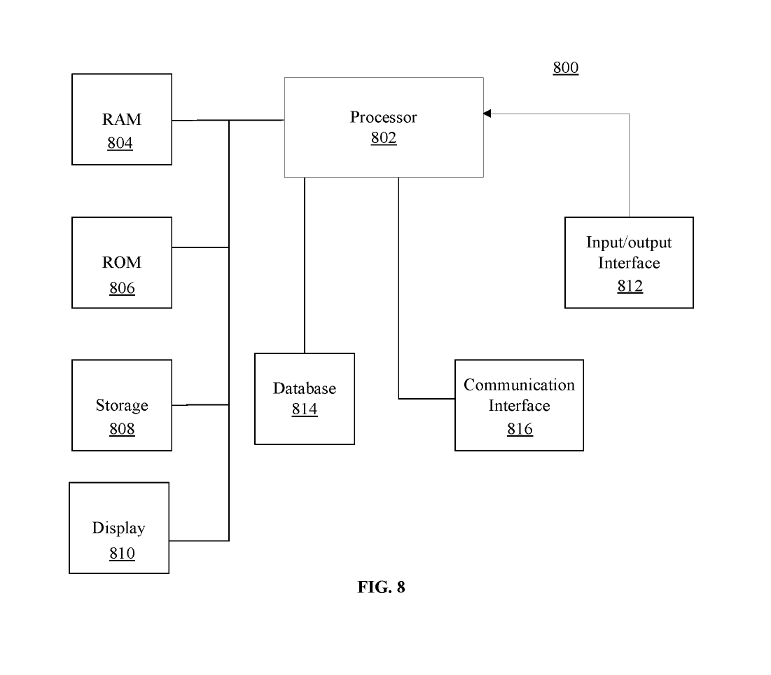

FIG. 7 illustrates a flow chart of another exemplary process of the interface-control method. As shown in FIG. 7, the process may include steps S701-S708.

In step S701, the controller may determine if the voltage on the first function pin is 0. If the voltage on the first function pin is 0, the process may end. If the voltage on the first function pin is not 0, the process may proceed to step S702.

In some embodiments, when the voltage on the first function pin is 0, the controller may determine the control module is not connected to a sensor module.

In step S702, the controller may determine if the signal on the first function pin is a DC signal. If the signal on the first function pin is a DC signal, the process may proceed to step S703. If the signal on the first function pin is not a DC signal, the process may proceed to step S705.

In step S703, the controller may obtain the voltage data based on the DC signal on the first function pin.

In step S704, the controller may determine the sensor type of the sensor circuit based on the voltage data.

For example, the controller may determine the sensor type of the sensor circuit based on the voltage data, i.e., the first data, and table 1.

After step S704 is executed, the controller may proceed to execute step S707.

In step S705, the controller may obtain the address data based on the signal on the first function pin. In one embodiment, the signal on the first function pin may be a square wave signal.

In step S706, the controller may determine the sensor type of the sensor circuit based on the address data.

For example, the controller may determine the sensor type of the sensor circuit based on the address data, i.e., the first data, and table 2.

In step S707, the controller may determine the processing type corresponding to the sensor circuit, based on the sensor type of the sensor circuit.

In step S708, the controller may process the measured data obtained from the sensor circuit, based on the processing type corresponding to the sensor circuit.

Optionally, after step S708, the process may further include, sending the result of the data processing to a server. The result may be used for suitable applications. For example, a user may receive the result from a mobile device, e.g., a mobile phone, that is connected to the server.

Optionally, after step S708, the process may further include, receiving a command from a user to control the on and off states of the light emitting module. For example, the user may confirm the receiving of the result by controlling the lighting emitting module to blink.

In one embodiment, the controller may obtain voltage data and/or address data through the signal transferred by the first function pin. The controller may determine the sensor type of the sensor circuit based on the voltage data and/or address data. The controller may further determine the processing type corresponding to the sensor circuit based on the sensor type corresponding to the sensor circuit. Further, based on the processing type corresponding to the sensor circuit, the measured data obtained from the sensor circuit may be processed. Thus, the control module may process data for sensor circuits of different sensor types.

It should be understood by those skilled in the art that, at least part of the method disclosed in the embodiments may be implemented through computer programs and related hardware. The computer programs may be stored in the readable medium of a computer. When the computer programs are being executed, the steps illustrated in FIGS. 6 and 7 may be executed. The readable medium may include one or more of a read-only memory (ROM), a random access memory (RAM), a disk, a compact disc (CD), and other suitable medium capable of storing computer programs.

FIG. 8 illustrates a block diagram of the controller 800 used in various embodiments of the present disclosure. The controller 800 may represent any controller 111 used in the embodiments of the present disclosure.

The controller 800 may receive, process, and execute commands from the LED lighting device. The controller 800 may include any appropriately configured computer system. As shown in FIG. 8, the controller 800 may include a processor 802, a random access memory (RAM) 804, a read-only memory (ROM) 806, a storage 808, a display 810, an input/output interface 812, a database 814; and a communication interface 816. Other components may be added and certain devices may be removed without departing from the principles of the disclosed embodiments.

Processor 802 may include any appropriate type of general purpose microprocessor, digital signal processor or microcontroller, and application specific integrated circuit (ASIC). Processor 802 may execute sequences of computer program instructions to perform various processes associated with controller 800. Computer program instructions may be loaded into RAM 804 for execution by processor 802 from read-only memory 806, or from storage 808. Storage 808 may include any appropriate type of mass storage provided to store any type of information that processor 802 may need to perform the processes. For example, storage 808 may include one or more hard disk devices, optical disk devices, flash disks, or other storage devices to provide storage space.

Display 810 may provide information to a user or users of the controller 800. Display 810 may include any appropriate type of computer display device or electronic device display (e.g., CRT or LCD based devices). Input/output interface 812 may be provided for users to input information into controller 800 or for the users to receive information from controller 800. For example, input/output interface 812 may include any appropriate input device, such as a keyboard, a mouse, an electronic tablet, voice communication devices, touch screens, or any other optical or wireless input devices. Further, input/output interface 812 may receive from and/or send to other external devices.

Further, database 814 may include any type of commercial or customized database, and may also include analysis tools for analyzing the information in the databases. Database 814 may be used for storing related information, e.g., Table 1 and Table 2. Communication interface 816 may provide communication connections such that controller 800 may be accessed remotely and/or communicate with other systems through computer networks or other communication networks via various communication protocols, such as transmission control protocol/internet protocol (TCP/IP), hyper text transfer protocol (HTTP), etc.

In one embodiment, the processor 802 may receive the first data through the communication interface 816. The processor 802 may refer to the table 1 or table 2 stored in the database 814 to determine the sensor type of the sensor circuit, based on the first data. The processor 802 may further determine the processing type based on the sensor type, and further process the measured data obtained from the sensor circuit based on the processing type.

For illustrate purposes, terms of “first”, “second”, and the like are used to merely distinguish different objects, and do not refer to any differences in function nor imply any order.

Modules and units used in the description of the present disclosure may each contain necessary software and/or hardware components, e.g., circuits, to implement desired functions of the modules.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the present disclosure, the first interface in the control module and the second interface in the sensor module may each include a first function pin. The controller may determine the sensor type of the sensor circuit based on the address data outputted by the first function pin. A sensor module containing a different type of sensor circuit may be connected to the control module through the same interface. Thus, the interface circuit may not need to be redesigned when a different sensor module is connected to the control module. Meanwhile, the present disclosure may also reduce the re-development of the control module. Less time is needed for the development of the interface-control device, and the manufacture of the interface-control device is cheaper.

Further, the first data may be used to indicate the sensor type of the sensor circuit, and the processing type corresponding to the sensor circuit may be determined. Further, based on the processing type corresponding to the sensor circuit, the measured data obtained from the sensor circuit may be processed. Thus, the control module may process data for sensor circuits of different sensor types.

Further, the controller may obtain voltage data and/or address data through the signal transferred by the first function pin. The controller may determine the sensor type of the sensor circuit based on the voltage data and/or address data. The controller may further determine the processing type corresponding to the sensor circuit based on the sensor type corresponding to the sensor circuit. Further, based on the processing type corresponding to the sensor circuit, the measured data obtained from the sensor circuit may be processed. Thus, the control module may process data for sensor circuits of different sensor types.

### REFERENCE SIGN LIST

Control module 11
Sensor module 12
Communication module 13
Light emitting module 14
Controller 111/800
First interface 112
Sensor circuit 121
Second interface 122
First function pin 1221
Second function pin 1222
Sensor sub-circuit 1212
Voltage dividing sub-circuit 1211
Processor 802
RAM 804
ROM 806
Storage 808
Display 810
Input/output interface 812
Database 814
Communication interface 816

What is claimed is:

1. An interface-control device, comprising: a control module having a controller and a first interface coupled to the controller, and a sensor module having a sensor circuit and a second interface coupled to the sensor circuit, the first interface and the second interface being connected through a matching connection, wherein:
the first interface and the second interface each includes a first function pin for transferring first data reflecting a sensor type of the sensor circuit from the sensor circuit to the controller; and
the controller determines the sensor type of the sensor circuit based on the first data and processes measured data from the sensor circuit based on the sensor type.

2. The interface-control device according to claim 1, wherein the first data include voltage data corresponding to the sensor type of the sensor circuit.

3. The interface-control device according to claim 2, wherein the first interface and the second interface each further includes a second function pin for transferring the measured data received from the sensor circuit to the controller.

4. The interface-control device according to claim 3, wherein the sensor circuit includes:
a voltage-dividing sub-circuit for outputting the first data, an output terminal of the voltage-dividing sub-circuit being coupled to the first function pin of the second interface; and
a sensor sub-circuit for outputting the measured data, an output terminal of the sensor sub-circuit being coupled to the second function pin of the second interface.

5. The interface-control device according to claim 4, wherein the first data is address data corresponding to the sensor type of the sensor circuit.

6. The interface-control device according to claim 5, wherein the first function pins transfer the address data and the measured data from the sensor circuit to the controller.

7. The interface-control device according to claim 1, wherein the first interface and the second interface may each be any one of a universal serial bus (USB) interface, a micro-USB interface, a 3.5 mm headphone jack, a male pin header connector, or a female pin header connector.

8. The interface-control device according to claim 1, further including a communication module coupled to the controller for transferring data between the controller and a server.

9. The interface-control device according to claim 8, wherein the communication module is one or more of a wireless fidelity (WiFi) communication module, a global system for mobile communications (GSM) communication module, a code division multiple access (CDMA) communication module, and a long term evolution (LTE) communication module

10. The interface-control device according to claim 1, further including a light emitting module coupled to the controller for providing lighting.

11. The interface-control device according to claim 10, wherein the light emitting module includes one or more light emitting diodes (LEDs).

12. An interface-control method for controlling the interface-control method according to claim 1, comprising:
obtaining the first data based on a signal transferred by the first function pin of the first interface, the first interface being coupled to the control module, first data indicating the sensor type of the sensor circuit;
determining a processing type corresponding to the sensor circuit based on the sensor type of the sensor circuit; and
processing the measured data obtained from the sensor circuit based on the processing type corresponding to the sensor circuit.

13. The interface-control method according to claim 12, wherein the first data include one or more of voltage data and address data.

14. The interface-control method according to claim 13, wherein obtaining the first data through the first function pin includes:
determining if the signal is a DC signal;
if the signal is a DC signal, obtaining the voltage data based on the DC signal; and
if the signal is not a DC signal, obtaining the address data based on a square wave signal transferred by the first function pin.

15. The interface-control method according to claim 12, further comprising: after processing the measured data, sending a result formed by processing the measured data to a server such that a user receives the result through a mobile device connected to the server.

16. The interface-control method according to claim 12, further comprising: after processing the measured data, receiving a command from a user to control on and off states of a light emitting module connected to the controller.
